(19) United States
(12) Patent Application Publication
(10) Pub. No.: US 2010/0131556 A1
(43) Pub. Date: May 27, 2010

(54) UNIFIED EVENT PROGRAMMING AND QUERIES

(75) Inventors: Henricus Johannes Maria Meijer, Mercer Island, WA (US); John Wesley Dyer, Monroe, WA (US); Jeffrey Van Gogh, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/277,862

(22) Filed: Nov. 25, 2008

(51) Int. Cl. G06F 17/30; G06F 7/00

(52) U.S. Cl. 707/771; 707/E17.014; 707/E17.136

(57) ABSTRACT

Event processing is transformed into query processing. Furthermore, asynchronous computation can be modeled as an event processing. Moreover, any computation that is or can be represented as push-based can be unified under an event-based processing approach subject to processing with query operators. Query processing can be performed with respect to one or more streams of events, wherein events identify a response to a raised value, among other things.

### CROSS-REFERENCE TO RELATED APPLICATIONS

This application is related to U.S. patent application Ser. No. ______ [Atty. Ref: MS325083.01/MSFTP2423US, Meijer, et al.], entitled EXCEPTIONAL EVENTS, filed Nov. 25, 2008, U.S. patent application Ser. No. ______ [Atty. Ref: MS325086.01/MSFTP2424US, Dyer, et al.], entitled EXPOSING ASYNCHRONOUS MECHANISMS AS FIRST-CLASS EVENTS, and U.S. patent application Ser. No. ______ [Atty. Ref: MS325085.01/MSFTP2448US, Meijer, et al.], entitled LAZY AND STATELESS EVENTS, all of even date. The entireties of these applications are incorporated herein by reference.

### BACKGROUND

Event-based systems comprise a plurality of independent program parts or components that communicate by way of notifications. Events generally correspond to notable conditions that cause a change of state such as sensor output, user action, or component message. In other words, an event is a message that indicates that something has happened. Event-based programs and/or portion thereof begin, wait for events, perform some action, and continue until explicitly terminated. By contrast, batch programs begin, perform an action, and stop.

Event-based programs are implemented with two main components: event triggers and event handlers. Triggers emit a signal or notification upon detecting the occurrence of an event. One or more event handlers respond to this notification by performing an action specific to the event. For example, upon detection of a button click, an event, some functionality is performed related to the click. Stated differently, a sender can detect an event and transmit a notification to a listening receiver, which can perform some designated action.

Furthermore, events are tightly coupled to classes similar to the relationship between a class and a class property. For instance, consider the following exemplary code snippet:

Button b=new Button( );

### b.Click+=DoSomething( );

Here, a new button “b” of type “Button” is constructed. Subsequently, an event “Click” is specified with respect to button “b,” and an event handler “DoSomething( )” is added to this event. Accordingly, both the event and the handler are tied to the “Button” class.

Asynchronous programming is conventionally distinct from event-based programming. Synchronous programming calls for a single execution path. By contrast, asynchronous programming employs multiple execution paths and concurrent operation. More specifically, a caller on a first thread can invoke a callee on a second thread that executes some functionality and returns a result to the caller. Moreover, asynchronous operations do not wait or block for a response from before continuing execution as is done with synchronous operations. Rather, the caller continues operation and is able to accept the result from the callee at anytime. Consequently, asynchronous programming is often employed with respect to time intensive tasks such as connecting to a remote computer and querying a database, among other things.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to employment of queries in conjunction with event-based processing systems and methods. Furthermore, push-based computation including but not limited to asynchronous programming can be unified under a single event-based framework. In any case, application of queries over events enables concise, declarative, and compositional program specification, among other things.

To enable such functionality, events are lifted to first class status. In other words, rather than being strongly coupled to a class, first-class events can be stored and passed around just as other constructs of such status. These first-class events can then be leveraged to represent various forms of push-based computation as well as support event processing utilizing queries, for example.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a system of event-based processing in accordance with an aspect of the disclosed subject matter.

FIG. 2 is a block diagram of trigger event interaction according to a disclosed aspect.

FIG. 3a is a consumer/producer stream diagram illustrating a pull-based model of computation.

FIG. 3b is a consumer/producer stream diagram depicting a push-based model of computation employed by event processing according to a disclosed aspect.

FIG. 3c is a consumer/producer stream diagram illustrating a manner of exception handing according to an aspect of the disclosure.

FIGS. 4a-b depict pull based and push based stream representations, respectively, in accordance with an aspect of the claimed subject matter.

FIG. 5 illustrates exemplary consumer and producer code associated with both push and pull based models of computation.

FIG. 6 is a block diagram of a system that converts pull-based computation into push-based computation according to a disclosed aspect.

FIG. 7a depicts the difference between synchronous and asynchronous programming according to a disclosed aspect.

FIG. 7b is a consumer/producer stream diagram illustrating an event-based representation of asynchronous computing in accordance with an aspect of the disclosure.

FIG. 8a illustrates a consumer/producer stream representation of exemplary discrete events in accordance with an aspect of the disclosure.

FIG. 8b depicts a consumer/producer stream representation of an exemplary continuous event according to a disclosed aspect.

FIG. 8c illustrates a discrete representation of continuous events in accordance with an aspect of the disclosure.

FIG. 9 is a block diagram of an event-based processing system in accordance with an aspect of the disclosure.

FIGS. 10a-b are consumer/producer event streams pertaining to correlated events according to an aspect of the claimed subject matter.

FIG. 11a is a consumer/producer event stream depicting chunking in accordance with an aspect of the disclosure.

FIG. 11b is a consumer/producer event stream illustrating grouping in accordance with an aspect of the disclosed subject matter.

FIG. 12a is a block diagram of an event-based processing system in accordance with an aspect of the disclosure.

FIG. 12b is graphical representation of an example depicting functionality afforded by the event-based processing system of FIG. 12a.

FIG. 13 is a flow chart diagram of an event construction method in accordance with an aspect of the disclosed subject matter.

FIG. 14 is a flow chart diagram of event-based processing in accordance with a disclosed aspect.

FIG. 15 is a flow chart diagram of a method of processing events according to an aspect of the disclosure.

FIG. 16 is a schematic block diagram of an exemplary system within which aspects of the disclosure can be practiced.

FIG. 17 is a schematic block diagram illustrating a suitable operating environment for aspects of the subject disclosure.

FIG. 18 is a schematic block diagram of a sample-computing environment.

### DETAILED DESCRIPTION

Systems and methods pertaining to event-based processing are described in detail hereinafter. Push-based computation is unified under a common root, namely event-based processing. For example, both graphical user interface events and asynchronous programming can be processed with respect to events. Furthermore, event-based processing can be transformed into query processing to facilitate composition and orchestration of asynchronous behavior, among other things. Consequently, programmers can express programs that are declarative, compositional, and concise.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

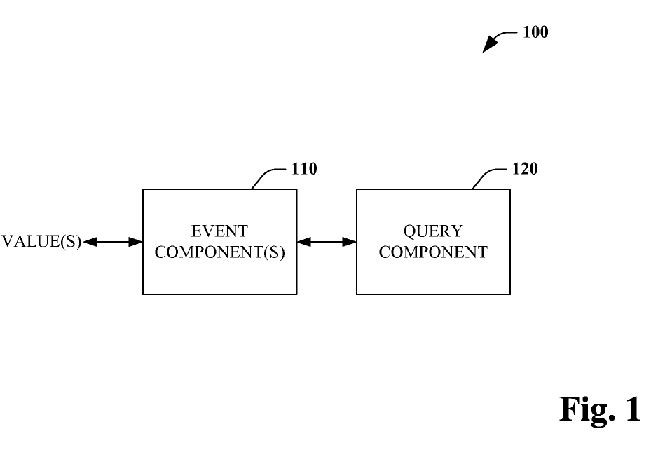

Referring initially to FIG. 1, an event-based processing system 100 is illustrated in accordance with an aspect of the claimed subject matter. As shown, the system 100 includes event component(s) 110 and a query component 120. Similar to conventional events, event component(s) 110 (or simply events 110) can capture an occurrence of something notable as well as one or more actions in response thereto. However, unlike conventional events that are tied to classes, for instance, event component(s) 110 can be first class constructs. In other words, event component(s) 110 can be stored and passed around, among other things, in the same manner as other constructs of this status such as integers or arrays

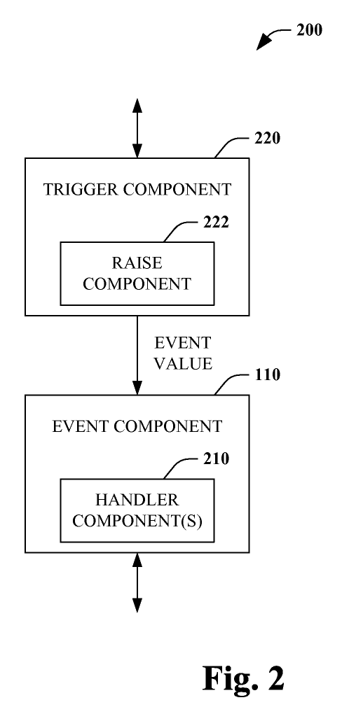

Turning attention briefly to FIG. 2, an event processing system 200 is depicted. The event component 110 can include one or more event handlers 210, which enable the event component 110 to react to an event value pushed thereto in one or more ways. Trigger component 220 includes a subcomponent 222 that enables an event to be triggered or raised with a value. While all triggers 122 are linked to an event 120, it should be appreciated that not all events 110 require triggers 220. In particular, events 110 that are associated with triggers 220 can be referred to as source events, whereas events 220 that do not employ triggers are constructed or composite events that depend from one or more source and/or composite events. Raising an event with a value is equivalent to pushing a value to an event component 110 upon which its one or more handlers 210 can operate.

Returning to FIG. 1, the query component 120 can interact with one or more event components 110 and/or event values in various ways. In general, the query component 120 enables query processing with respect to one or more events 110. In other words, the query component 120 can apply a variety of query operators including but not limited to “Select,” “Where,” “Join,” and “Merge” to events 110. In one implementation, the query component 120 can facilitate construction or composition of an event 110 as function of one or more source and/or composite events 110. To this event, handlers can be added. Streams of event values can then be analyzed with respect to one or more query operators defining an event to determine whether or not a particular event has been raised with a value. It is within this context that other aspects of the claimed subject matter can be clearly described and appreciated. Of course, the claimed subject matter is not so limited.

Furthermore, it should be appreciated that event solutions can be domain specific and require specialized (query/programming) languages for a domain. For example, a language can be designed for event-based graphical user interfaces, or SQL (Structured Query Language) may be employed for event processing in the database world. Here, however, a wide-range of event-based processing approaches can be unified under a common framework. In essence, a commitment to any specific model of how the world works can be avoided. Rather, a set of rich operations for dealing with any form of pushed-based computation is afforded, among other things. Stated differently, query operators can be domain independent.

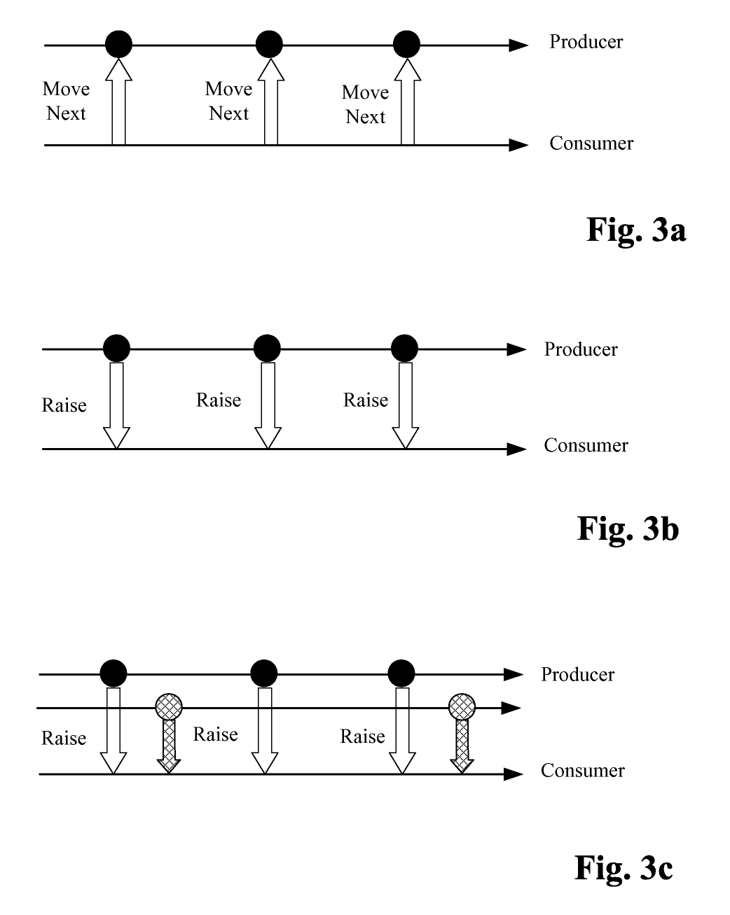

FIGS. 3a and 3b illustrate the difference between push and pull models of computation. FIG. 3a is a consumer/producer stream diagram showing a traditional pull model. Here, the consumer is in control and asks the producer to deliver each value in a sequence in a synchronous fashion. A move next instruction is issued by the consumer to the producer which and then afford a value or signals back that it is exhausted. By contrast, FIG. 3b is a consumer/producer stream diagram depicting a push-based model of computation upon which event processing is based. In this scenario, the producer is in control and pushes values to the consumer in an asynchronous manner. At a high level of abstraction, this is a unifying theme amongst all different event-processing systems. It is an inversion of control as in “Don't call us, we'll call you.” Consumers subscribe to events from the producer by registering event handlers that are invoked whenever the producer pushes a new value.

FIG. 3c is a consumer/producer stream diagram illustrating a manner in which failure or exceptions can be handled in accordance with an aspect of the claimed subject matter. As will be further appreciated with respect to latter discussion of asynchronous events, failure can occur anywhere in computation. Conventionally, such failures are termed exceptions and they are treated differently than regular events, especially in a pull-based computation model. In accordance with an aspect of the disclosure, exceptional results and normal results can be unified in the event-based world. As shown, a producer can raise either a normal or an exceptional value. Here, a different stream is employed for exceptional results. However, a single stream can be employed with a disjoint or discriminated union of normal and exceptional results. In any case, it is to be appreciated that handlers can now be added with respect to normal and exceptional results.

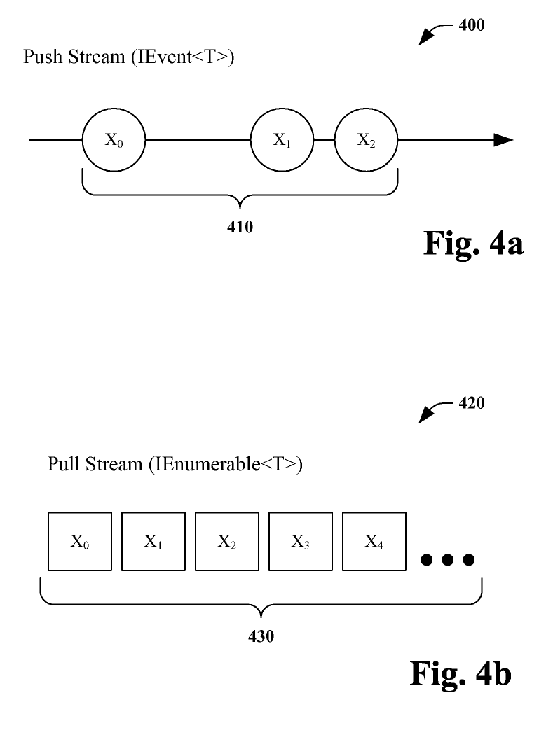

FIGS. 4a and b depict representations of a push stream 400 and a pull stream 420. The push stream 400 includes a plurality of events 410. The events can be implemented in accordance with an event interface “IEvent<T>,” for example. The pull stream 420 includes numerous events 430, which can be implemented in accordance with a collection interface “IEnumerable<T>.” It is to be noted that both streams 400 and 420 are potentially infinite sequences with deferred execution.

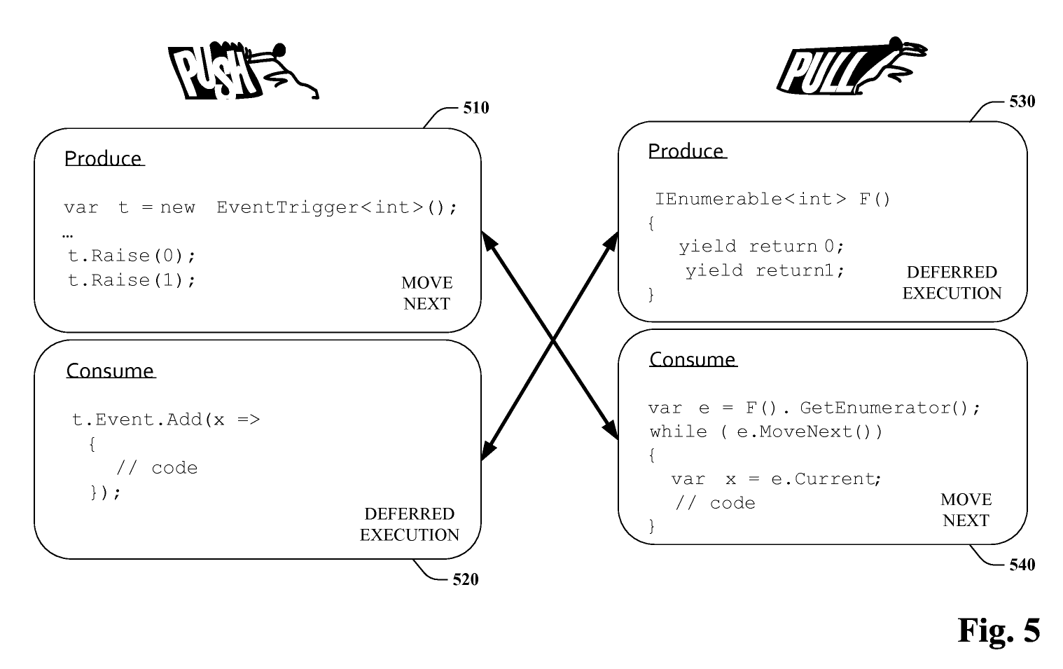

Referring to FIG. 5, exemplary code for consumers and producers of push-based and pull-based models is provided. On the push side, producer code 510 raises or generates two event values (0 and 1) that are pushed to a consumer. Consumer code 520 provides event handlers that will perform some action on received event values. On the pull side, producer code 530 provides the same two values afforded by the corresponding producer component 510. Here, however, execution is deferred until a request is provided from consumer code 540. In particular, the consumer code 540 provides functionality for iterating over the collection of integer values provided by the producer code 530.

While the push and pull sides are operate differently, they have common properties. First, there is a move next style function in the push side producer 510 and the pull side consumer 540. Second, there is deferred execution in the push side consumer 520 and the pull side producer 540. In light of the similar properties, according to an aspect of the claimed subject matter pull-based computations can be converted into push-based computations.

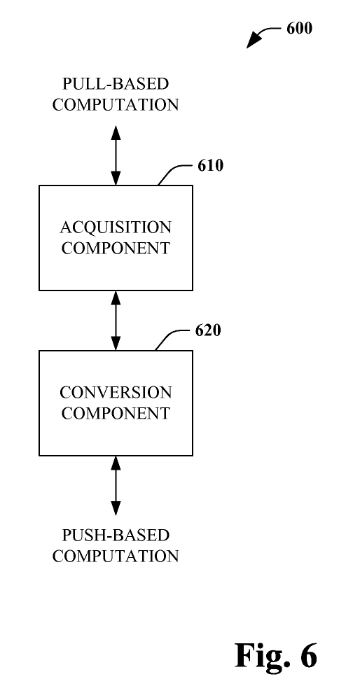

FIG. 6 illustrates a conversion system 600 in accordance with an aspect of the claimed subject matter. Acquisition component 610 can receive, retrieve, or otherwise obtain or acquire pull-based code or computation such as that associated with a producer and consumer. The conversion component 610 accesses the acquired pull-based code and either converts that code into push-based computation or generates new equivalent push-based computation. In this manner, substantially all computations can be represented as push-based and can thus be unified with an event-based processing system in conjunction with query functionality, among other things.

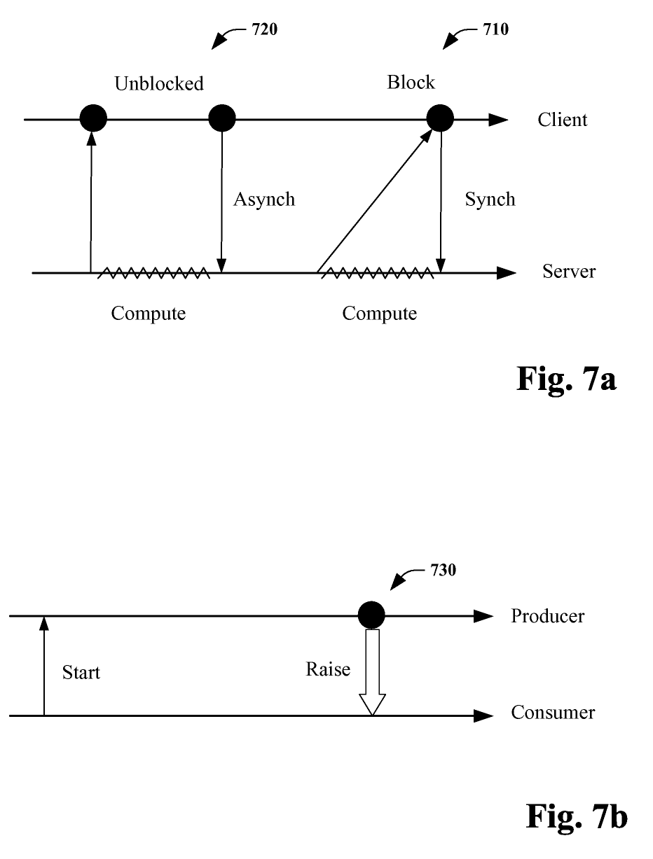

FIG. 7a graphically depicts the difference between synchronous and asynchronous computation. As per synchronous processing 710, a client makes a call to a server to perform some computation and it blocks until the server completes the computation and calls back to the client. Alternatively, with respect to asynchronous processing 710 a client can initiate a computation by a server and continue processing. In other works, the client is unblocked. At some time after initiation, the server can provide the result of the computation back to the client. In one embodiment, a client can provide the server with a callback function to invoke upon completion, although it is not required.

Turning attention to FIG. 7b, a consumer/producer stream diagram illustrates an exemplary event-based representation of asynchronous computing in accordance with an aspect of the claimed subject matter. Conventionally, people distinguish asynchronous computations from event-based processing and event streams in particular. However, there is no reason to draw such a distinction. As shown, events can be employed to represent asynchronous processing. More specifically, a consumer or calling program can initiate execution by a producer. Upon termination of an asynchronous computation, an event 730 is raised and pushed to the consumer. Here, the raised event includes the result of the computation performed by the producer. As previously mentioned, where the computation fails the raised event can correspond to an exception thereby notifying the consumer of the failure. In any case, asynchronous computing can be unified with event-based processing utilizing a single event to return a value.

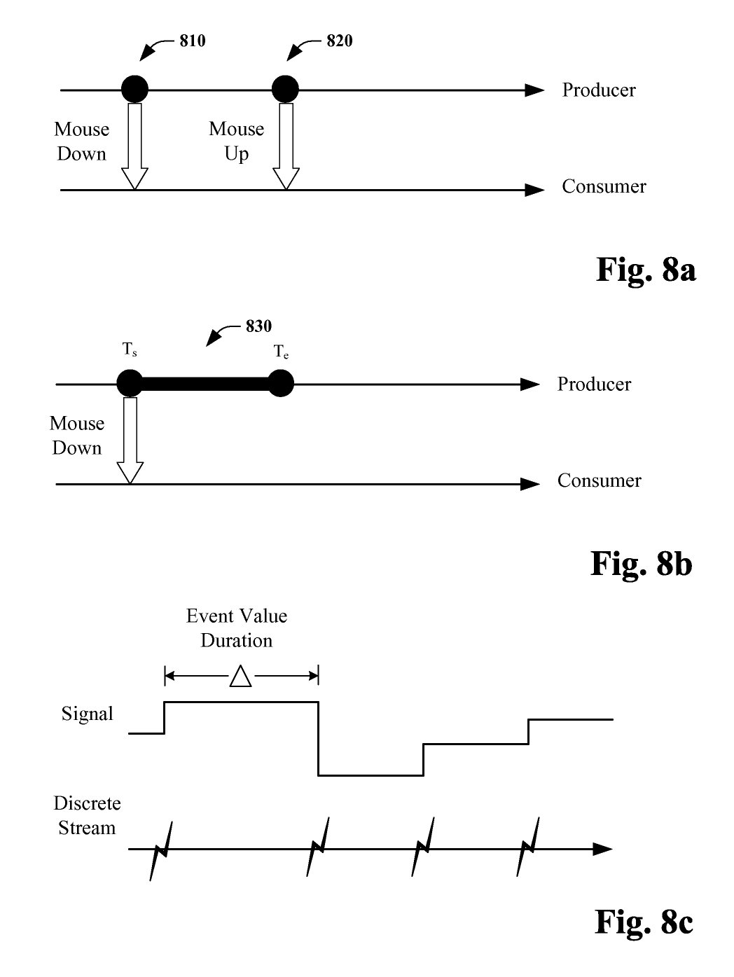

Conventionally a distinction is also made between so-called discrete events and continuous events. However, in accordance with an aspect of the claimed subject matter these two types of events can be unified. FIG. 8a illustrates a producer/consumer stream with two discrete events, namely mouse down 810 and mouse up 820. In other words, an event happens such as a down mouse click 810, then nothing happens, then another event occurs such as an up mouse click 820. FIG. 8b illustrates a continuous event representation of the same mouse click scenario. Here, however, it is represented as a down mouse click 830 that remains down for a period of time until the mouse button is released, for example. In general, continuous events behave like signals as shown in FIG. 8c.

Continuous or signal-like events can be modeled as edge triggered discrete events, among other things. Rather than having an event maintain a value for a specific period of time, it can be noted when an event acquires a value and then no longer has the value. For example, consider a mouse over event. This could be represented with a single continuous event “mouse on” that has a one value that is valid while the mouse is on or more something. Alternatively, the same functionality can be implemented with two discrete events such a “mouse in” and “mouse out,” where an event is fired when the mouse moves into an area and another event is fired when the mouse moves out of an area.

As shown in FIG. 8c, upon and up edge an event occurs and then another event occurs on the down edges. This is analogous to the manner in which edge triggered flip-flops or the like operate. The point is that continuous events are discrete anyway. They have a beginning and an end. In some sense the representations are isomorphic, but in one representation one does not have to deal with whether or not something has a current value or not. It may seem problematic that an event state is not observational. However, where necessary the last value of the event can be re-triggered or additional events can adjust an interval after the fact. Furthermore, other implementations/embodiments are also possible including, without limitation, allowing an event to carry information about its duration.

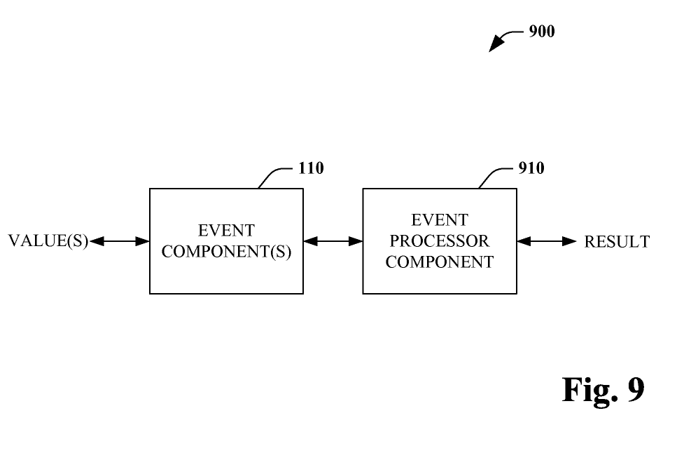

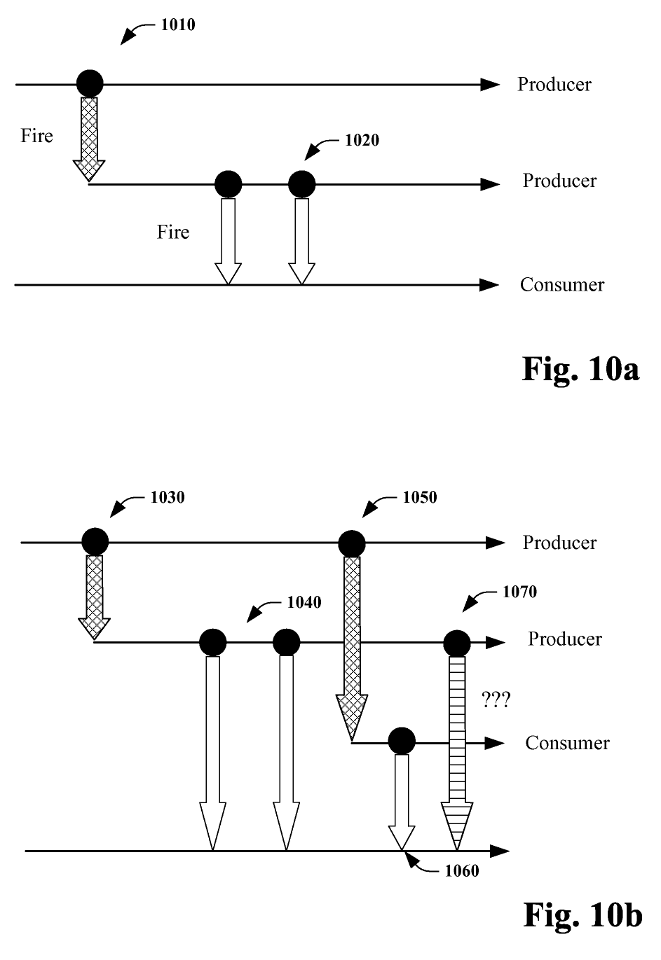

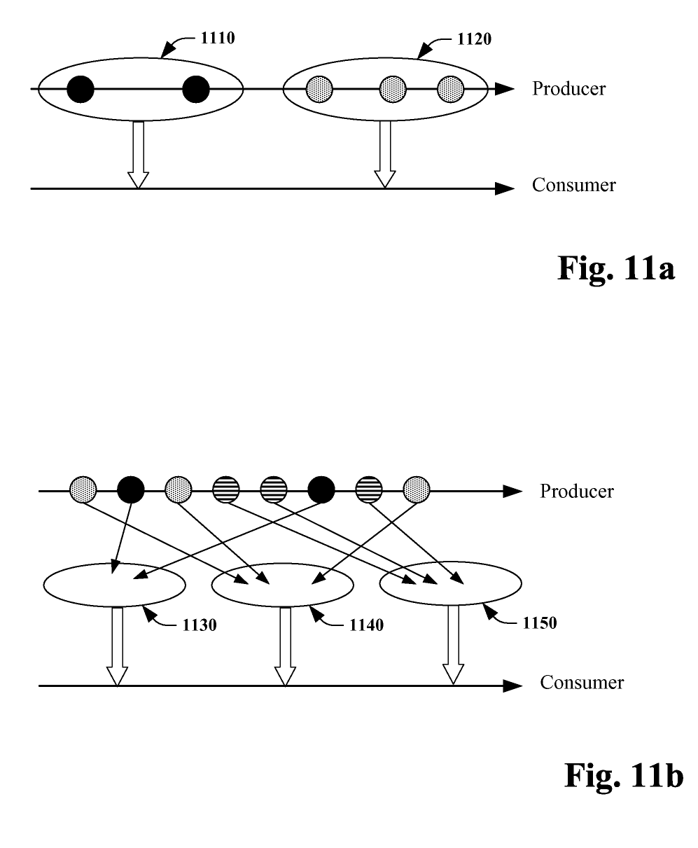

Referring briefly to FIG. 9, an event processing system 900 is illustrated in accordance with an aspect of the claimed subject matter. Similar to system 100 of FIG. 1, system 900 includes the event component(s) 110 as previously described. However, it should be noted that events are not solely subject to basic query operations. In fact, events can be subject to any type of processing, as streams thereof can be a just another data source. In particular, collections of events can implement standard sequence operators and as such can be subject to any type of processing associated with such a data type. As provided here, event processor component 910 is able to execute many kinds of functionality over events such as complex event processing including, among other things, correlation, filtering, scanning, transforming, parsing and/or regular expression pattern matching. Furthermore, the event processor component 910 can perform any of the functions performed by the query component 120 of FIG. 1. System 900 is provided merely to highlight the fact that events are not subject to processing solely with respect to conventional or known query operations. A few examples of operations capable of being performed by the processor component 910 are described with respect to FIGS. 10 and 11.

FIGS. 10a-b depicted consumer/producer event streams pertaining to correlated events in accordance with an aspect of the claimed subject matter. Correlated events are new event streams caused by previous events. Alternatively, correlated events can be termed composite or compositional events for the same reason. A standard sequence operator that that encapsulates correlation is “SelectMany,” sometimes also called “Bind.”

As shown in FIG. 10a, an event on the first producer stream 1010 is fired which causes a new producer event stream to be generated. Subsequently, events or sub-events 1020 on the second producer stream are fired, which are projected down to the consumer event stream. Correlated sub-events open up a new design space as well as some issues associated with the space. The richness of the design space is caused by the push factor of event streams, which in general will allow arbitrary interleaving of sub-event streams originating from a first event stream.

FIG. 10b illustrates a more complex use of correlated events. Similar to FIG. 10a, FIG. 10b includes a correlate event 1030, which generates a new producer stream upon which two events or sub-events 1040 fire and are flattened or projected onto the consumer stream. Furthermore, the first producer stream includes another event 1040 that produces yet another producer event stream, which has an event 1060 fire, which is projected to the consumer event stream. Subsequently, the second producer stream fires another event 1070. Here, the question is does whether or not the event 1070 is projected to the consumer.

This issue, which can also be referred to as a causality error, results from the push and asynchronous nature of the computation. In a normal pull-based system, the consumer is in charge and can determine when things happen. In a push-based setting, however, there is no way to sequence the producers. This ordering issue can be a potential problem. For example consider a dictionary suggest application where as a user types calls are made to a server to return suggestions. Here, server requests can easily come back out of order. Consequently, the application can have stale data presented, if not careful.

The issue is how to deal with cases like the one presented in FIG. 10b. In one implementation, the event 1070 will be projected to the consumer even though it occurred after a more recent intermediate producer produced. In a different implementation, this type of projection might not be allowed. This basically says that once an intermediate producer is produced all previous producers are silenced. This is essentially enforcing order and it takes a more conservative approach as to how things are pushed forward. A slightly more permissive implementation might dictated that instead of silencing all previous intermediate producers, they are only silenced once the most recent producer produces a new event value.

Turning attention to FIGS. 11a-b, two consumer/producer event streams are shown demonstrating event processing in accordance with an aspect of the claimed subject matter. FIG. 11a illustrates chunking or shallow parsing of event streams. In other words, individual events or chunks are combined into larger groups of events. Here, the first two events are combined into collection 1110 and the last three events are combined into collection 1120. FIG. 11b depicts a grouping of events in accordance with a grouping function. In particular, a grouping function can take events and produces keys upon which grouping can be based. In this case, events are combined into three groups 1130, 1140, and 1150, as a function of their fill pattern (e.g., solid, stripped, dotted). Essentially, an event stream of event streams or a two-dimensional event stream is constructed. If a hander is added to a resulting event stream, it will fire whenever a new group is discovered. It can fire with a key to allow a handler to be added that acquires all the values that will be in that event stream.

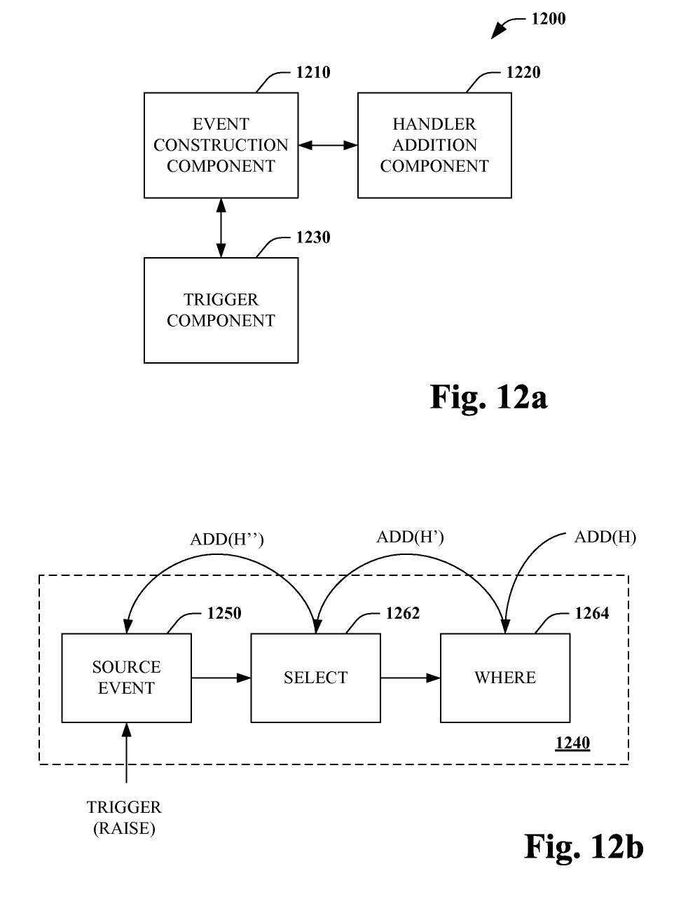

FIG. 12a is a system of event processing 1200 in accordance with an aspect of the claimed subject matter. The system 1200 includes an event construction component 1210 that enables or facilitates construction or composition of an event as a function of sequence and/or query operators, among other things. For example, an event can be composed that includes a superset or subset of one or more source events. Handler addition component 1220 is a mechanism for adding event handlers to a constructed event. In accordance with an aspect of the disclosure, event handlers are composed on source events, rather than on leaf nodes of a constructed event, in a cascading fashion (and can be removed similarly). Furthermore, the system 1200 includes a trigger component 1230 that triggers or raises a constructed event by way of one or more source events.

Turning attention to FIG. 12b, a graphical depiction of at least a portion of functionality provided by system 1200 of FIG. 12a is provided. An event 1240 is constructed from a source event 1250 with query operators select 1262 and where 1264. For purposes of simplicity, assume the select and where operators 1262 and 1264, respectively, seek out only even event values or filter out odd values from the source event 1250. Accordingly, the constructed event 1240 corresponds to a derivation or subset of the source event 1250 that includes only even events. A hander can be added to the constructed event 1240 such as multiple the event value by five. However, rather than being added to the output of the where operator 1264, the handler can be propagated in a cascading manner up to the source event such that upon triggering of the source event 1250 the handler will be invoked as intended. Here, for example, conditional code or functionality can be added to the source event such that if an event occurs and the value of that event is even then the value is multiplied by five.

While the above example is simple on purpose, it is to be appreciated that the same or analogous functionality can be provided with respect to more complex scenarios enabled by the system 1200 of FIG. 12a. By way of example and not limitation, drag and drop functionality can be implemented in this manner in accordance with the following exemplary code snippet:

```
var leftButton = (from down in div.GetMouseDown( )
      where down.LeftButtonClicked
      select new HtmlMouseEventArgs(down.X, down.Y, true, false))
  .Merge(from up in Document.GetMouseUp( )
      where up.LeftButtonClicked
      select new HtmlMouseEventArgs(up.X, up.Y, false, false));
var deltas = from mouseStart in leftButton
      from delta in Document.GetMouseMove( )
          .Scan(Event.Delta(mouseStart, (previous, current) =>
```

| | |
|---|---|
| new{ | X = current.X − previous.X, |
| | Y = current.Y − previous.Y})) |

```
      where mouseStart.LeftButtonClicked select delta;
    deltas.Add(delta =>
        {
            div.Style.Left = (div.OffsetLeft + delta.X) + “px”;
            div.Style.Top = (div.OffsetTop + delta.Y) + “px”;
        });
```

Here, two events are constructed utilizing query operations, namely “leftbutton” and “deltas” that is derived from “leftbutton.” Two handlers are added to the “deltas” event. Of course, events can also support many specialized operations, so called “non-proper morphisms.” These include but are not limited to conversions between event streams and convention pull based collections, various grouping and chunking operations, scanning, and parsing.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, events and/or event handlers can incorporate such mechanisms.

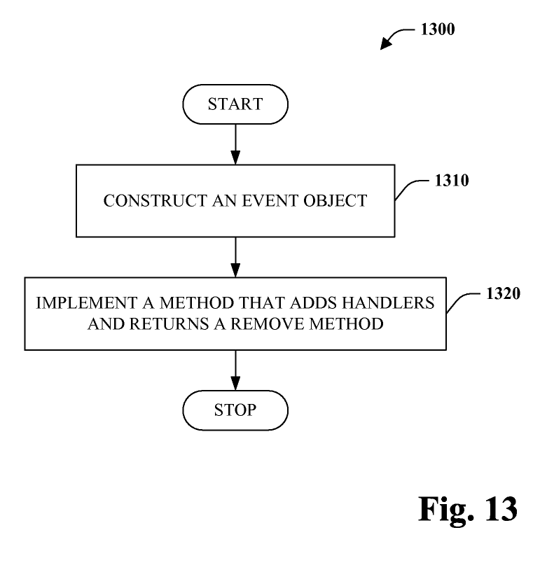

In view of the exemplary systems described supra, methodologies that may be implemented in accordance with the disclosed subject matter will be better appreciated with reference to the flow charts of FIGS. 13-15. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 13, a method of event construction 1300 is illustrated in accordance with an aspect of the claimed subject matter. At reference numeral 1310, an event object is constructed. In accordance with one aspect of this disclosure, an event can be a first-class program construct rather than a second-class construct tied to a class, for instance. An event can define an occurrence of an event and a value associated therewith. At numeral 1320, a method is implemented to facilitate addition of event handlers that specify a reaction to the occurrence of an event. In accordance with one embodiment, handlers can be resident solely on source events. Accordingly, where a handler is specified on a constructed or composite event, the add method can enable the handler to be propagated to the source event such that invocation of the handler on the source is equivalent to invocation on a composite event. In other words, event handlers can be composed in the same or similar manner in which events themselves are composed. It should also be appreciated that the add method can return a function execution of which removes a handler from an event. In one implementation the add method signature can be “Add(Action<T>handler):Action.” Further yet, it is to be appreciated that more than one hander can be added. For example, action can be specified for successes and failures, among others.

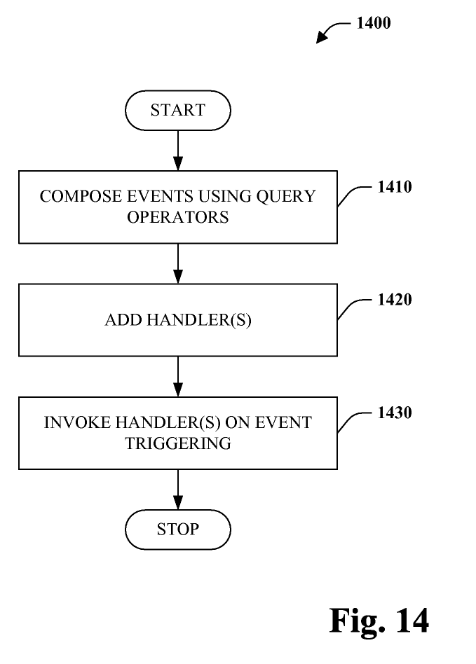

FIG. 14 depicts a method of event-based processing in accordance with an aspect of the claimed subject matter. At reference numeral 1410, an event is constructed with one or more query operators. The query operators can be standard and/or complex operators, for example, pertaining to grouping, filtering, mapping, correlation, aggregation, scanning, parsing, and regular expression pattern matching, among others. Furthermore, the query operators can be domain independent. At numeral 1420, handlers are added to the constructed event, which in one embodiment can be propagated to source events. At reference 1430, event handlers are invoked upon triggering or raising of an event. Among other things, this method provides support for a concise, declarative, and compositional event processing and/or interaction.

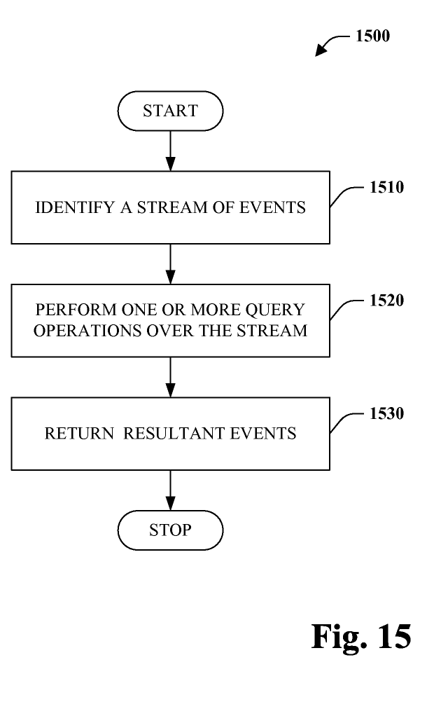

Turning attention to FIG. 15, a flow chart diagram of a method of event processing 1500 is depicted in accordance with an aspect of the claimed subject matter. At 1510, a stream of events and/or event values is identified. In accordance with one embodiment, this stream can correspond to all events generated be a computer. For example, the stream can include events from various sources such as a timer, an XML (Extensible Markup Language) push parser, graphical user interface, and/or an asynchronous program. However, the stream can also be a subset or superset of one or more source and/or composite event streams. One or more query operations or the like can be performed over the identified stream at 1520. For example, these query operations can be specified by a programmer to identify and/or process specific events in particular manners. Subsequently, results of the query operation can be returned. For instance, resultant events can be pushed to a known or newly generated event stream.

In accordance with an aspect of the disclosure a rich set of algebraic operator, such as query operators, can be employed for event-based processing. These operators have their roots in the mathematical theory of monads. Briefly, a monad allows computation to be described without actually executing the computation. Further, the computation can be parameterized by some type or value. In this case, it is desirous to describe some operations such as queries over event sources or event streams. This implies that what we want is actually a monad. An example of a monad that is familiar is a list or the like. What is described next is how events or streams of events are monads.

Two operations needed for a monad are a unit function and a bind function. Here, the unit function can correspond to the query operator “Return” and the bind function can correspond to the “SelectMany” query operator. As per “Return,” it takes a “T” and returns an “IEvent<T>.” For example, if it is desired that the value five be returned for an event stream, the query operator can return “Event.Return(5).” In this operator “T” is an “INT” and what is returned is “IEvent<INT>” or an event stream of integers. The event stream will have one event, and the value of that event is that provided, namely five. When a handlers is added to this event stream, only one event will fire, which has a value of five. In other words, a value that is not in the monad or event world is injected into the monad or event world. The “Return” operation takes this integer and puts it inside an event stream, so that it can be dealt with through further computations.

Bind or SelectMany is more complicated. In general, bind takes an “IEvent<T>” and a function “T” to “IEvent<U>” and returns “IEvent<U>.” In other words, it takes an event stream and a function that produces a new event stream and outputs the new event stream. Notice that the event streams are parameterized by the event value type they carry. “IEvent<T>” means it carries event values of type “T.” There is no way for anyone to get at that event value directly. In general, this is a key point of monads. If there is something in a monad, in this case an event value, there is no way to access the event value without knowing something about the type that carries the event value. For example, if the monad is a list of “T” and you want to acquire elements in the list, you need to know something about lists. What bind does is it takes the source collection “IEvent<T>” and a function that takes values that are of the type in that collection and produces a new collection with a different value type. This is depicted graphically with respect to FIG. 10a.

Recall, bind has two parameters, namely a source event stream, which is the top producer line in FIG. 10a and a function that takes event values and produces a new event stream, which corresponds to the hatched arrow from the first producer line to the second producer line. The function takes event values as its source and produces new event streams. In other words, every time a dot occurs a new line is produced, correlating the source event with this generated event. The final result is the consumer line, which is the line “IEvent<U>.” The way the consumer line is produced is essentially by flattening the resulting lines from function application. Stated differently, the produced streams are projected to the final consumer stream.

The “SelectMany” operator comes into play when there are multiple sources, for instance as shown in FIG. 10b. For example, one can say from “x” in “foo” and from “y” in “bar.” Then, this bind can be used to combine these two streams together in a form such that the values accessible. Note that “foo” and “bar” do not have to be the same event value type. “Foo” could be of type integer while “bar” is of type string. What is happening here is source event values are bound to the “T” in the function from “T” to “IEvent<U>” Once elements are bound a specification of what to do with the event values and how to produce a new stream is executed. Subsequently, results can be flattened which is not trivial in a push-based model. In particular, a push-based model is more difficult to deal with than a pull-based model since events can happen at any time and an event stream is infinite. More specifically, a decision needs to be made as to what action to take when events come back out of order. In any event, event streams or push based infinite collections do in fact have a the required bind and the semantics of the bind can take into account the fact that events can come back out of order.

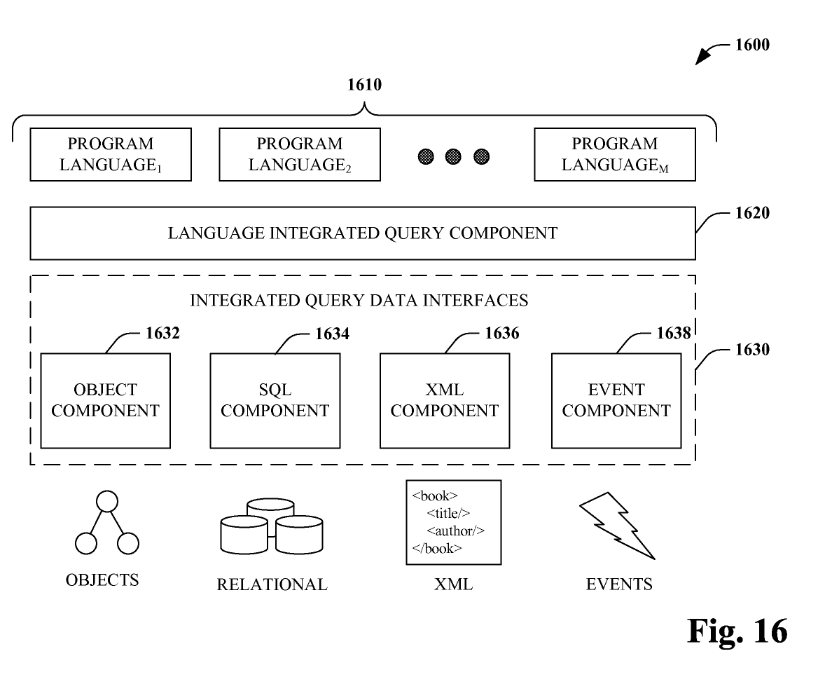

Turning attention to FIG. 16, an exemplary system 1600 is provided for which aspects of the claimed subject matter can be employed. In particular, the system 1600 can operate over a plurality of programming languages 1610 (PROGRAM LANGAUGE₁-PROGRAM LANGUAGE_{M}, where M is an integer greater than or equal to one). For example, such languages can include but are not limited object-oriented languages such as to C#, Visual Basic, and Java. Further, the system 1600 includes a language integrated query component, facility or the like 1620. This component 1620 enables integration of declarative style queries, similar to those utilized with respect to SQL (Structured Query Language), to be integrated with a user's primary programming language 1610. Further, the component 1620 allows query expressions to benefit from compile-time syntax checking, static typing, and intelligent assistance, among other things previously only available to imperative code. Additionally, the system 1600 includes a plurality of integrated query data interfaces 1630. These interfaces 1630 allow queries over different types of data. As shown, object component 1632 enables queries over objects; SQL component 1634 allows structured query language queries over relational data; and XML component 1636 enables interaction with extensible markup language (XML) data. Moreover, event component 1638 enables language-integrated queries over events. It is here where aspects of the claimed subject matter can be incorporated. By way of example and not limitation, language embedded queries can be performed over streams of one or more events to enable event processing by way of queries, thereby affording a concise, declarative, and compositional manner of event interaction. Appendix A provides a list of potential query operators that can be employed in accordance with aspects of the claimed subject matter.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

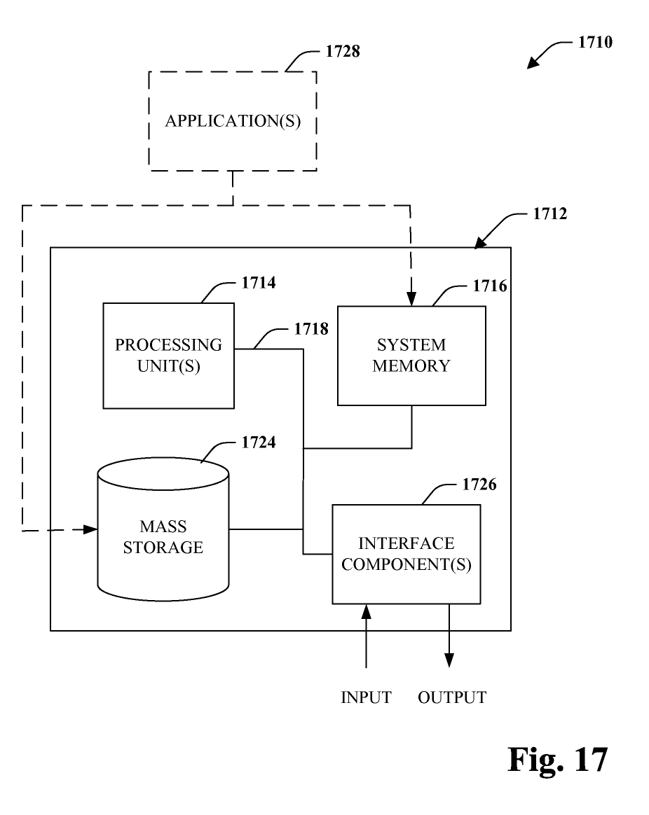

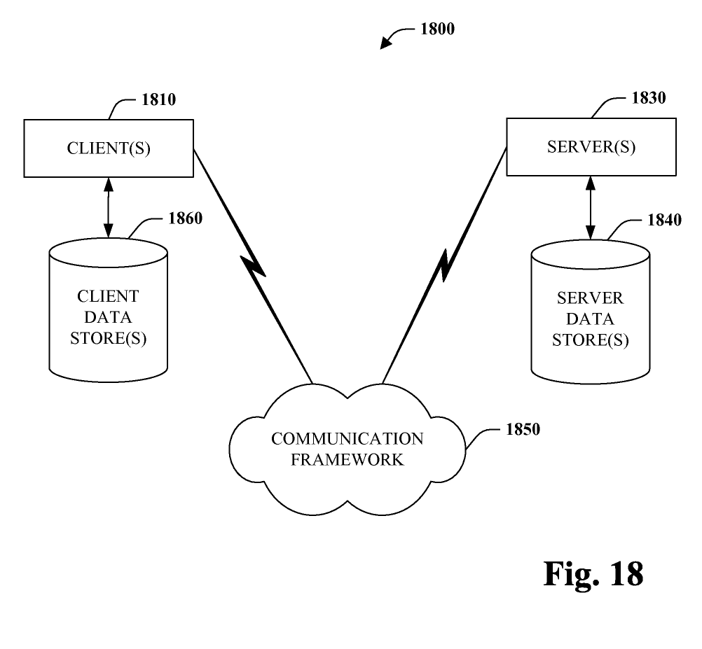

In order to provide a context for the various aspects of the disclosed subject matter, FIGS. 17 and 18 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 17, an exemplary environment 1710 for implementing various aspects disclosed herein includes a computer 1712 (e.g., desktop, laptop, server, hand held, programmable consumer or industrial electronics . . . ). The computer 1712 includes a processing unit 1714, a system memory 1716, and a system bus 1718. The system bus 1718 couples system components including, but not limited to, the system memory 1716 to the processing unit 1714. The processing unit 1714 can be any of various available microprocessors. It is to be appreciated that dual microprocessors, multi-core and other multiprocessor architectures can be employed as the processing unit 1714.

The system memory 1716 includes volatile and nonvolatile memory. The basic input/output system (BIOS), containing the basic routines to transfer information between elements within the computer 1712, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1712 also includes removable/non-removable, volatile/non-volatile computer storage media. FIG. 17 illustrates, for example, mass storage 1724. Mass storage 1724 includes, but is not limited to, devices like a magnetic or optical disk drive, floppy disk drive, flash memory, or memory stick. In addition, mass storage 1724 can include storage media separately or in combination with other storage media.

FIG. 17 provides software application(s) 1728 that act as an intermediary between users and/or other computers and the basic computer resources described in suitable operating environment 1710. Such software application(s) 1728 include one or both of system and application software. System software can include an operating system, which can be stored on mass storage 1724, that acts to control and allocate resources of the computer system 1712. Application software takes advantage of the management of resources by system software through program modules and data stored on either or both of system memory 1716 and mass storage 1724.

The computer 1712 also includes one or more interface components 1726 that are communicatively coupled to the bus 1718 and facilitate interaction with the computer 1712. By way of example, the interface component 1726 can be a port (e.g., serial, parallel, PCMCIA, USB, FireWire . . . ) or an interface card (e.g., sound, video, network . . . ) or the like. The interface component 1726 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer, and the like. Output can also be supplied by the computer 1712 to output device(s) via interface component 1726. Output devices can include displays (e.g., CRT, LCD, plasma . . . ), speakers, printers, and other computers, among other things.

FIG. 18 is a schematic block diagram of a sample-computing environment 1800 with which the subject innovation can interact. The system 1800 includes one or more client(s) 1810. The client(s) 1810 can be hardware and/or software (e.g., threads, processes, computing devices). The system 1800 also includes one or more server(s) 1830. Thus, system 1800 can correspond to a two-tier client server model or a multi-tier model (e.g., client, middle tier server, data server), amongst other models. The server(s) 1830 can also be hardware and/or software (e.g., threads, processes, computing devices). The servers 1830 can house threads to perform transformations by employing the aspects of the subject innovation, for example. One possible communication between a client 1810 and a server 1830 may be in the form of a data packet transmitted between two or more computer processes.

The system 1800 includes a communication framework 1850 that can be employed to facilitate communications between the client(s) 1810 and the server(s) 1830. The client(s) 1810 are operatively connected to one or more client data store(s) 1860 that can be employed to store information local to the client(s) 1810. Similarly, the server(s) 1830 are operatively connected to one or more server data store(s) 1840 that can be employed to store information local to the servers 1830.

Client/server interactions can be utilized with respect with respect to various aspects of the claimed subject matter. By way of example and not limitation, events can be generated by a server 1830 and communicated to a client 1810 across the communication framework 1850. In one specific implementation, such client/server interactions can facilitate asynchronous processing where the server 1830 performs some computation and pushes by the result as an event value to a client 1810 over the communication framework 1850.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

### APPENDIX A

### Exemplary Query Operators for Events:

CacheValue
CallCC
Catch
Choose
Defer
Delay
Distinct
Do
Flatten
GetEvent
GroupBy
GroupJoin
GroupUntil
Hold
Intersect
Iterate
Join
Latch
Let
Memoize
Merge
Never
Occurred
Parallel
Partition
Prepend
Range
Recurse
Repeat
Return
Run
RunOne
RunOnEventLoop
RunOnNewThread
RunOnScheduler
RunOnThreadPool
RunOnUIThread
Sample
Scan
Select
SelectMany
SelectManyAll
Series
Share
Skip
SkipWhile
Sleep
Start
Synchronize
Take
TakeWhile
Throttle
Throw
Timeout
TimeoutWithValue
Timer
ToAsync
ToEnumerable
ToEvent
Toggle
Union
Unwrap
Unzip
Wait
WaitOne
Where
WithoutValue
WithValue
Wrap
Zip

What is claimed is:

1. An event-based processing system, comprising:
a push stream of one or more event values associated with the occurrence of an event; and
a query component that executes a domain independent query operator over the push stream of event values and returns a result push stream of event values.

2. The system of claim 1, the event value is a return result of an asynchronous computation, wherein a consumer of the event value is unblocked while it awaits the value.

3. The system of claim 1, the event values are related to a graphical user interface event.

4. The system of claim 1, the event values are edge triggered to afford a discrete representation of a continuous event.

5. The system of claim 1, the event values of a push stream are employed by handlers to perform one or more actions registered on a related event.

6. The system of claim 1, further comprising a trigger component that raises event values on the push stream.

7. The system of claim 1, the query operator performs complex event processing including at least of correlation, filtering, transforming, scanning, parsing, regular expression pattern matching, or grouping.

8. The system of claim 1, the query operator implements a standard language integrated query pattern.

9. The system of claim 1, the query component facilitates program language integrated queries over push streams of event values.

10. A computer-implemented method of event processing, comprising:
acquiring one or more push streams of event values associated with different sources that identify the occurrence of events and values associated with the events;
applying one or more domain independent query operators over the one or more streams of events; and
returning a resultant stream of events that reflects application of the one or more query operators to the one or more acquired streams.

11. The method of claim 10, comprising acquiring a push stream of a single event value that corresponds to the result of an asynchronous call.

12. The method of claim 10, comprising acquiring a push stream of events associated with graphical user interface actions.

13. The method of claim 10, comprising acquiring a push stream that includes at least one event indicative of a failure or exception.

14. The method of claim 10, comprising acquiring a push stream that includes event values that correspond to edges associated with initialization and termination of continuous events.

15. The method of claim 10, comprising acquiring a push stream of event values that is composed from at least one other push stream of event values.

16. The method of claim 10, further comprising applying correlation to perform at least one of filtering, transforming, scanning, parsing, regular expression pattern matching, or grouping.

17. The method of claim 10, further comprising adding event handlers for resultant stream events.

18. A computer-readable medium having stored thereon computer executable code, comprising:
a first-class event object; and
a method for adding an event handler to the event that performs an action in response to a raised event.

19. The computer-readable medium of claim 18, the method for adding an event handler facilitates propagation of a hander of equivalent functionality to a source event.

20. The computer-readable medium of claim 18, further comprising a method for removing a handler returned by the method for adding the handler.
